(19) United States
(12) Patent Application Publication
(10) Pub. No.: US 2017/0147976 A1
(43) Pub. Date: May 25, 2017

(54) METHOD AND SYSTEM OF COORDINATING A DELIVERY BY A SELECTED DELIVERY AGENT TO A DELIVERY RECIPIENT

(71) Applicant: AT&T INTELLECTUAL PROPERTY I, L.P., Atlanta, GA (US)

(72) Inventors: Robert Alan KOCH, NORCROSS, GA (US); Ari CRAINE, MARIETTA, GA (US)

(73) Assignee: AT&T INTELLECTUAL PROPERTY I, L.P., Atlanta, GA (US)

(21) Appl. No.: 14/949,322

(22) Filed: Nov. 23, 2015

(51) Int. Cl. G06Q 10/08; G06Q 30/02

(52) U.S. Cl. CPC G06Q 10/0833; G06Q 10/0836; G06Q 30/0235

(57) ABSTRACT

A method includes coordinating delivery by a selected delivery agent to a delivery recipient. A geographical receiving location for a delivery recipient is determined. A delivery agent, of a plurality of potential delivery agents, is identified and selected that is capable of delivering a specific product to the delivery recipient at the geographical location for the delivery recipient, in which the identifying includes analyzing planned geographical routes for each of the plurality of potential delivery agents to determine the delivery agent. A network communications address of the delivery recipient is determined and an electronic communication exchange is established between an entity responsible for providing the product to the delivery recipient and the network communications address of the delivery recipient. The specific product is assigned for delivery to the delivery recipient based on the communications exchange.

### BACKGROUND

1. Field of the Disclosure

The present disclosure relates to the field of product delivery. More particularly, the present disclosure relates to coordinating a delivery by a selected delivery agent to a delivery recipient.

2. Background Information

Consumers demand faster access to goods that they intend to purchase. Promised delivery times for purchased items have been continually shortened to meet consumer demand. However, a need for real-time or near real-time delivery exists for many products.

### BRIEF DESCRIPTION OF THE DRAWINGS

FIG. 1 shows an exemplary general computer system that includes a set of instructions for coordinating a delivery by a selected delivery agent to a delivery recipient, according to an aspect of the present disclosure;

FIG. 2 shows an exemplary system for coordinating a delivery by a selected delivery agent to a delivery recipient, according to an aspect of the present disclosure;

FIG. 3 shows an exemplary flowchart for coordinating a delivery by a selected delivery agent to a delivery recipient, according to an aspect of the present disclosure;

FIG. 4 shows an exemplary networked coordinator of the system for coordinating a delivery by a selected delivery agent to a delivery recipient, according to an aspect of the present disclosure;

FIG. 5 shows an exemplary flowchart for pre-positioning products based on predicted purchases and predicted geographic locations, according to an aspect of the present disclosure;

FIG. 6A shows an exemplary user interface with pushed content from a supplier to a user device of an opt-in user, according to an aspect of the present disclosure;

FIG. 6B shows an exemplary user interface with pushed content from a supplier to a user device, according to an aspect of the present disclosure;

FIG. 7 shows an exemplary map of an exemplary map of predicted locations of opt-in users for a given time, according to an aspect of the present disclosure;

FIG. 8 shows an exemplary map of predicted locations of opt-in users having a predicted likelihood of purchasing a particular product for a given time, according to an aspect of the present disclosure;

FIG. 9 shows an exemplary system for communications between a user communications device and an operator communications device, according to an aspect of the present disclosure; and

FIG. 10 shows an exemplary flowchart for coordinating a delivery by a selected delivery agent to a delivery recipient, according to an aspect of the present disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods. Further, any reference to claim elements in the singular, for example, using the articles “a,” “an” or “the”, is not to be construed as limiting the element to the singular.

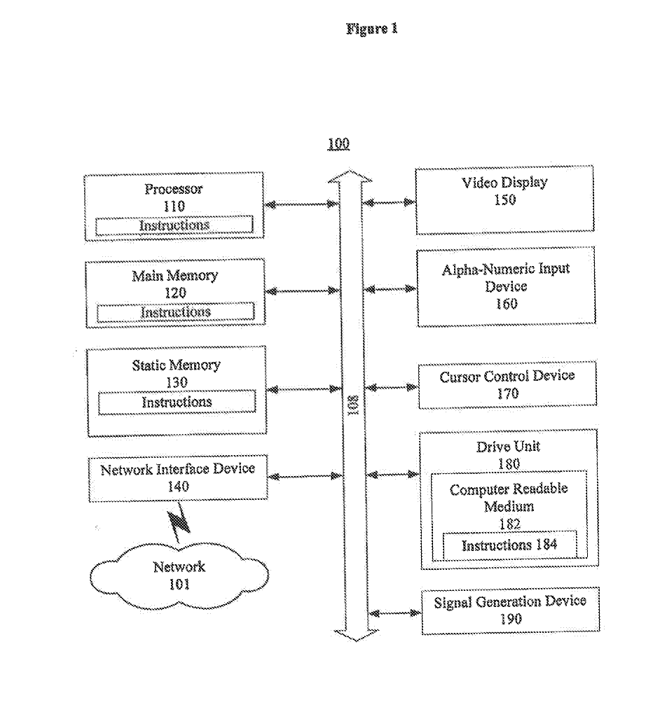

FIG. 1 is an illustrative embodiment of a general computer system, on which a method of a method and system for coordinating a delivery by a selected delivery agent to a delivery recipient can be implemented, and which is shown and is designated 100. The computer system 100 can include a set of instructions that can be executed to cause the computer system 100 to perform any one or more of the methods or computer based functions disclosed herein. The computer system 100 may operate as a standalone device or may be connected, for example, using a network 101, to other computer systems or peripheral devices.

In a networked deployment, the computer system 100 may operate in the capacity of a server or as a client user computer in a server-client user network environment, or as a peer computer system in a peer-to-peer (or distributed) network environment. The computer system 100 can also be implemented as or incorporated into various devices, such as a stationary computer, a mobile computer, a personal computer (PC), a laptop computer, a tablet computer, a wireless smart phone, a set-top box (STB), a personal digital assistant (PDA), a global positioning satellite (GPS) device, a communications device, a control system, a camera, a web appliance, a network router, switch or bridge, networked coordinator, or any other machine capable of executing a set of instructions (sequential or otherwise) that specify actions to be taken by that machine. The computer system 100 can be incorporated as or in a particular device that in turn is in an integrated system that includes additional devices. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 includes a processor 110. A processor for a computer system 100 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. A processor is an article of manufacture and/or a machine component. A processor for a computer system 100 is configured to execute software instructions in order to perform functions as described in the various embodiments herein. A processor for a computer system 100 may be a general purpose processor or may be part of an application specific integrated circuit (ASIC). A processor for a computer system 100 may also be a microprocessor, a microcomputer, a processor chip, a controller, a microcontroller, a digital signal processor (DSP), a state machine, or a programmable logic device. A processor for a computer system 100 may also be a logical circuit, including a programmable gate array (PGA) such as a field programmable gate array (FPGA), or another type of circuit that includes discrete gate and/or transistor logic. A processor for a computer system 100 may be a central processing unit (CPU), a graphics processing unit (GPU), or both. Additionally, any processor described herein may include multiple processors, parallel processors, or both. Multiple processors may be included in, or coupled to, a single device or multiple devices.

Moreover, the computer system 100 includes a main memory 120 and a static memory 130 that can communicate with each other via a bus 108. Memories described herein are tangible storage mediums that can store data and executable instructions, and are non-transitory during the time instructions are stored therein. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. A memory described herein is an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted.

As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard/virtual keyboard or touch-sensitive input screen or speech input with speech recognition, and a cursor control device 170, such as a mouse or touch-sensitive input screen or pad. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g. software, can be embedded. Sets of instructions 184 can be read from the computer-readable medium 182. Further, the instructions 184, when executed by a processor, can be used to perform one or more of the methods and processes as described herein. In a particular embodiment, the instructions 184 may reside completely, or at least partially, within the main memory 120, the static memory 130, and/or within the processor 110 during execution by the computer system 100.

In an alternative embodiment, dedicated hardware implementations, such as application-specific integrated circuits (ASICs), programmable logic arrays and other hardware components, can be constructed to implement one or more of the methods described herein. One or more embodiments described herein may implement functions using two or more specific interconnected hardware modules or devices with related control and data signals that can be communicated between and through the modules. Accordingly, the present disclosure encompasses software, firmware, and hardware implementations. Nothing in the present application should be interpreted as being implemented or implementable solely with software and not hardware such as a tangible non-transitory processor and/or memory.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

The present disclosure contemplates a computer-readable medium 182 that includes instructions 184 or receives and executes instructions 184 responsive to a propagated signal; so that a device connected to a network 101 can communicate voice, video or data over the network 101. Further, the instructions 184 may be transmitted or received over the network 101 via the network interface device 140.

The Internet has helped to contribute to an instant gratification mentality, with content on most anything available for viewing and only a click away. As a result, a problem exists in delivering instant gratification to users in the form of real-time or near real-time product delivery. Thus, the aspects discussed herein solve this challenge particular to the Internet.

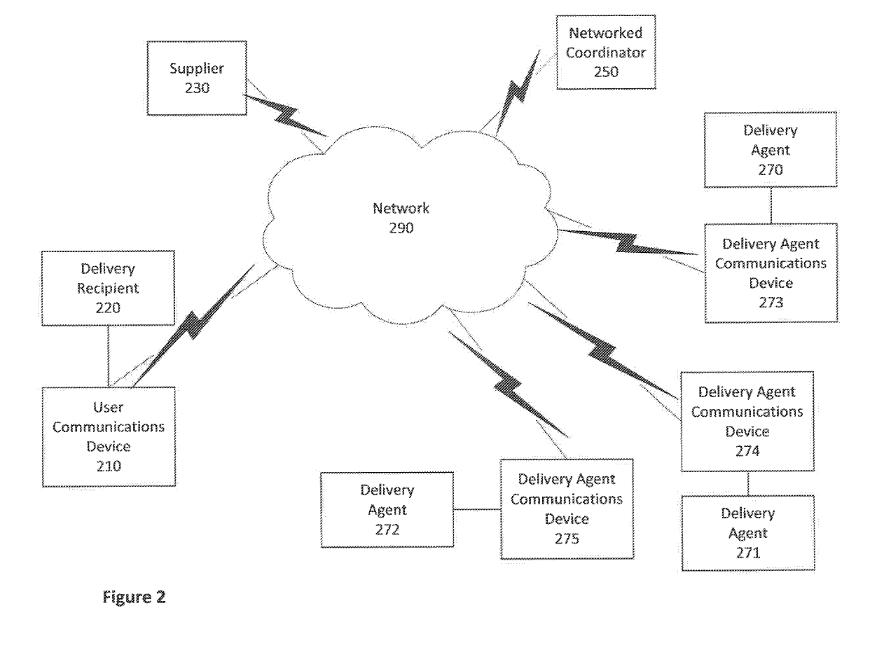

In FIG. 2, an exemplary system for coordinating a delivery by a selected delivery agent to a delivery recipient is shown. The system 200 includes a user communications device 210, a delivery recipient 220, a supplier 230, a networked coordinator 250, a plurality of delivery agents 270, 271, 272 having respective delivery agent communications devices 273, 274, 275, and a network 290. While FIG. 2 depicts a given number of elements, any number is possible.

The user communications device 210, also referred to herein as a user device 210, is operated by a user (e.g., a delivery recipient 220) and includes any user device configured to send and receive information over a network such as the network 290. The network 290 may be the Internet, a wide area network (WAN), a local area network (LAN), a wireless local area network (WLAN), or other suitable network configured for transmission of communications between elements on a network. The network 290 may be configured to enable a radio connection through a radio network access such as the global system for mobile communications (GSM), including variants and equivalents thereof. The network 290 may be configured for use with other wired and wireless communication protocols, including TCP/IP, user datagram protocol (UDP), WiFi, real-time transport protocol (RTP), short message service (SMS), session initiation protocol (SIP), code division multiple access (CDMA), time division multiple access (TDMA), etc.

In one embodiment, the user of the user device 210 is the delivery recipient 220. Alternatively, a proxy for the user of the user device 210 may be the delivery recipient 220. In this regard, the user may designate one or more proxies authorized to accept deliveries on behalf of the user.

Exemplary user devices 210 may include a computer, a mobile computer, a PC, a laptop computer, a tablet computer, a wireless smart phone, a cell phone, a mobile phone, a tablet, an STB, a PDA, a GPS, a camera, a web appliance, smart glasses, etc. The user device 210 also includes a client application that enables the transmission and reception of data from other communications devices on the network 290. The user device 210 is configured to communicate with other communications devices on the network 290 via email, short message service (SMS), direct messaging, instant messaging (IM), text messaging, internet relay chat (IRC), chat programs, audio and/or video communications, social networking, and all other comparable and equivalent communication modalities. Further, the user device 210 is able to communicate in conjunction with cellular networks, the public switched telephone network (PSTN), or other networks suitable for voice and/or data communication.

In one embodiment, the delivery recipient 220 can opt-in to a system with which the aspects of the present disclosure operate. The system may be provided by the supplier 230, networked coordinator 250, and/or other entity. By employing a networked coordinator 250, faster computational processing times can be achieved.

With the opt-in embodiment, the delivery recipient 220 performs an initial registration process with, for example, the supplier 230, networked coordinator 250, and/or other entity, in which relevant delivery recipient 220 profile information is entered using, for example, the user device 210 to interact with an appropriate online interface associated with the supplier 230 or other entity. Information entered by the delivery recipient 220 is stored in an appropriate database or other storage accessible by the supplier 230 and/or the networked coordinator 250. Such profile information may include, a name of the delivery recipient 220, an address of the delivery recipient 220, delivery preferences of the delivery recipient 220, daily itinerary information of the delivery recipient 220, a work schedule of the delivery recipient 220, times that the delivery recipient 220 is most likely at a home address, times that the delivery recipient 220 is most likely at a work address, times that the delivery recipient 220 is most likely at other locations such as a particular golf course, product preferences of the delivery recipient 220, hobbies of the delivery recipient 220, a purchase history of the delivery recipient 220 with the supplier 230, and/or an online browsing history of the delivery recipient 220 with the supplier 230. In this regard, the profile information may be a combination of information provided by the delivery recipient, and information collected about the delivery recipient 220, e.g., web browsing habits, online browsing history with the supplier, etc. In one embodiment, the supplier 230 may send the web browsing habits, online browsing history with the supplier, etc. to be stored with the user profile information, for example, at the networked coordinator 250.

In one aspect, the itinerary of the delivery recipient 220 is used to predict a future geographical location of the delivery recipient 220. In one embodiment, the delivery recipient 220 indicates a desire to share their current location with the system, in which case GPS coordinates are sent from the user device 210 to the networked coordinator 250 for example, continuously or at predefined intervals.

With a non-opt-in embodiment, the delivery recipient 220 does not register with the supplier 230, networked coordinator 250, or other entity. In the non-opt-in embodiment, geographical location information of the delivery recipient 220 may be obtained via GPS coordinates of the user device 210 that are transmitted to the networked coordinator 250. For delivery recipients 220 who do not opt-in, geographical location information of the delivery recipient 220 may be obtained by a component, for example, in the networked coordinator 250 that receives a geographical location information of the delivery recipient from a wireless carrier of the user device 210 via cellular tower triangulation and/or GPS signals from the user device 210, i.e., when the user device 210 is a mobile communications device. In one aspect, the delivery recipient 220 must allow GPS tracking of the user device 210.

In one embodiment, address or location information provided by the delivery recipient 220 during registration or an updated registration is converted to GPS coordinates, for example, by a component running at the networked coordinator 250. Geographical location information of the delivery recipient 220 at particular days/times may be used to provide products to the delivery recipient 220 in a real-time or near real-time fashion.

Regardless of whether the opt-in or non-opt-in embodiment is implemented, the geographical location of the user device 210 may be established using a collection of location coordinates based on a satellite navigation system such as GPS, the Globalnaya Navigazionnaya Sputnikovaya Sistema (GLONASS) global position system, the Galileo navigation satellite system, the global navigation satellite system (GNSS), the Indian Regional Navigation Satellite System (IRNSS), the Quasi-Zenith Satellite System (QZSS), and/or the BeiDou navigation satellite system (BDS) also known as Compass. It is understood that GPS as used herein is an umbrella term for the aforementioned systems, unless otherwise noted. In an alternative, the location of the user device 210 may be determined based on the cellular network via cellular tower triangulation or a WiFi network via the WiFi based positioning system (WPS) or WiPS/WFPS, for example, if GPS is affected by multipath or signal blockage. It is understood that a combination of any or all of these modalities may be employed to establish the location of the user device 210.

In one embodiment, when the supplier 230 receives an order from the delivery recipient 220 of the user device 210, an application running at the supplier 230 requests the user device 210 to transmit location information of the user device 210 at periodic intervals. The request may be in the form of a web page having an icon requesting that the delivery recipient 220 click to initiate the transfer of location information. Location information received by the supplier 230 may be transmitted to the networked coordinator 250.

The supplier 230 includes a web server (not shown) having an appropriate interface with which users may interact via the user device 210. The supplier 230 includes an application programming interface (API) 232 with which the supplier 230 may interact with other entities. The supplier 230 is configured to interact directly with the user device 210, the networked coordinator 250, and/or the delivery agent communications devices 273, 274, 275 of the delivery agents 270-272. Additionally, the supplier 230 includes all of the necessary elements, including front end and back end systems, that would allow an online merchant to do business, including applications for managing inventory, billing, shipping, scheduling, etc.

The networked coordinator 250 is a networked element configured to interface between the supplier 230 and the delivery agent communications devices 273, 274, 275 via the network 290. In one embodiment, the networked coordinator 250 is a part of the supplier 230 or is a manager of the delivery agents 270-272. The networked coordinator 250 may reside at or separately from the supplier 230 and/or manager of the delivery agents 270-272. In another embodiment, the networked coordinator 250 is independent from the supplier 230 and the delivery agents 270-272 and may be operated by another entity. If the network coordinator 250 is configured to accept registration information from the delivery recipient 220, then an appropriate interface and API is included. In one embodiment, the networked coordinator 250 is a processor or a plurality of processors.

The networked coordinator 250 may be configured to determine or receive a geographical location of the delivery recipient 220 in a manner discussed above. The geographical location of the delivery recipient 220 may be the location of the user device 210 of the delivery recipient 220, a future location of the user device 210 of the delivery recipient 220, a predicted location of the user device 210 of the delivery recipient 220, a predicted future location of the user device 210 of the delivery recipient 220, or a geographical location designated by the delivery recipient 220 associated with the user device 210. In one embodiment, the determination may include using a location prediction engine, as will be discussed later, that creates an aggregated map view based on where an opt-in delivery recipient is likely to be and when, for example, a current or future location. The determination may also be based on a user profile during registration, including a shared itinerary. The various elements of the networked coordinator are configured to use any suitable predictive modelling technique.

The networked coordinator 250 identifies a delivery agent (e.g., delivery agent 270), of the one or more delivery agents 270-272, capable of making a delivery of a specific product to the delivery recipient 220 at a geographical location of the delivery recipient 220. The supplier 230 may have an arrangement with one particular delivery agent 270, or one particular delivery agent 270 in one geographical area. In one embodiment, the specific product is pre-positioned with a delivery agent 270 known or predicted to be traversing an area near to the delivery recipient 220 or near to an expected area of the delivery recipient 220.

The networked coordinator 250 includes a processor, as shown in FIG. 1, configured to receive a traffic information source over a network, and receive live traffic information from the traffic information source at predetermined intervals, e.g., every five minutes. The networked coordinator 250 is also configured to communicate with a source of road map information, which may be a part of or distinct from the traffic information source. The networked coordinator 250 is configured to receive data with, for example, GOOGLE™ Maps and GOOGLE™ Traffic, or equivalent tools. The networked coordinator 250 combines data regarding the delivery recipient 220, supplier 230, and/or delivery agents 270-272 to plan routes, coordinate delivery agents 270-272 using up to date traffic information, to improve delivery times.

In one embodiment, the networked coordinator 250 identifies and selects the delivery agent 270 using geographical route information or potential geographical router information of each of the one or more delivery agents 270-272 to determine a delivery agent 270 capable of making the delivery of the specific product.

In one embodiment, the geographical route information of each of the one or more delivery agents 270-272 is ascertained by GPS coordinates of the delivery agent communications devices 273, 274, 275 in combination with stored known routes of the respective delivery agents 270-272. That is, the networked coordinator 250 determines the location of the delivery agent communications devices 273, 274, 275 via GPS coordinates transmitted from the delivery agent communications devices 273, 274, 275 to the networked coordinator 250. In one embodiment, the delivery agents 270-272 have assigned routes, which may be accessible to the networked coordinator 250. In other embodiment, the delivery agents 270-272 have no particular assigned routes, e.g., UBER™ drivers. For example, a UBER™ driver may pick up a specific product to be pre-positioned with the UBER™ driver, from a FEDEX™ agent, other courier, warehouse, or other suitable location.

The networked coordinator 250 may use the potential or planned route of the one or more delivery agents 270-272 to determine whether an overlap or near overlap exists between the one or more delivery agents 270-272 and the geographical location information of the delivery recipient 220, as will be discussed below.

For example, the networked coordinator 250 uses a mapping analysis to determine which of the one or more delivery agents 270-272 will be along a route near to the shipping destination of the delivery recipient 220. The mapping analysis includes the collection and analysis of road traffic data with actual and/or potential delivery route information. In one embodiment, the geographical routes of the one or more delivery agents 270-272 are pre-planned routes. For example, on Saturdays, delivery agent 270 exits Interstate 20 at a particular exit and a particular time of the day.

The networked coordinator 250 determines a network communications address of the user device 210 of the delivery recipient 220 by which the delivery recipient 220 may be accessed by a selected one of the delivery agents 270-272. The network communications address of the user device 210 may be, for example, a telephone number, an IP address, an email address, a SIP address, etc. In one embodiment, the networked coordinator 250 may obtain the network communications address of the delivery recipient 220 via information stored at the supplier 230 or with the one or more delivery agents 270-272. The network communications address of the delivery recipient 220 may have been stored as part of a registration process in the opt-in embodiment, or may have been provided by the delivery recipient 220 to the supplier 230 during a previous purchase process. Alternatively, the networked coordinator 250 may obtain the network communications address of the delivery recipient via direct communication with the delivery recipient 220.

The networked coordinator 250 may also determine a communications address of the delivery agent 270 (e.g., the communications device 273) identified from the one or more delivery agents 270-272. The communications address of the delivery agent may be, for example, a telephone number, an IP address, an email address, a SIP address, etc. In one embodiment, a communications address of each of the delivery agent communications devices 273, 274, 275 is stored at the networked coordinator 250 and/or the supplier 230. If the communications address of the potential delivery agent 270 identified from the one or more delivery agents 270-272 is not stored at the networked coordinator 250, then the networked coordinator 250 can obtain the communications address from the supplier 230 via communications over the network 290 or can request the communications address of the potential delivery agent 270 via communication over the network 290 or other modalities.

The networked coordinator 250 establishes a communications session between the network communications address of the user device 210 of the delivery recipient 220 with the communications address of the delivery agent 270. Thus, the delivery recipient 220 does not have to share their communications address with the delivery agent 270. The communications session may take any form including text-based, audio and/or video. For example, the networked coordinator 250 can automatically set up a chat session between the delivery recipient 220 and the identified delivery agent, e.g., delivery agent 270. The chat session may be set up by the networked coordinator 250 when the delivery agent is within a certain proximity to the delivery recipient 220.

In one embodiment, the networked coordinator 250 can send an identifier to the delivery recipient 220, which the delivery recipient 220 can access, for example, by clicking from the user device 210, which will initiate a communications chat session between the delivery recipient 220 and the potential delivery agent 270. For example, in one embodiment, clicking on the identifier by the delivery recipient 220 of the user device 210 will launch a dashboard or other interface that will allow entry of live chat information on the user device 210. In this regard, an appropriate interface may be provided on the user device 210 and respective user devices of the delivery agents 270-272 with a similar dashboard. In one aspect, a similar or same identifier is also sent to the delivery agent 270 to launch a similar dashboard. The dashboard, in one example, includes an appropriate chat window by which the parties can input text information.

In one embodiment, a third-party voice bridge is established by the networked coordinator 250. That is, the networked coordinator 250 sends a meeting invitation with a voice bridge phone number and conference code to both of the delivery recipient 220 and the delivery agent 270. When the participants receive the meeting invitation, they enter the phone number on their communications device 210, 273 which establishes a conference bridge. Rather than a conference bridge, a video bridge, thus allowing the delivery recipient 220 is able to see the actual product on board with the delivery agent 270 is also possible.

In one embodiment, the networked coordinator 250 sends a link to the delivery recipient 220 and the delivery agent 270 (e.g., <a href=“tel:+18001234567”>call now</a>. Thus both the delivery recipient 220 and the delivery agent 270 would click the link on their respective communications devices to join the conference bridge associated with the number assigned to the link. In another embodiment, a URL may be sent to both the delivery recipient 220 and the delivery agent 270, which would open an IM chat session between the delivery recipient 220 and the delivery agent 270 (e.g., IM:<sip:smith@IMemail.com>. In another embodiment, a video call, video chat, or video conference may be initiated in response to the delivery recipient 220 and the delivery agent 270 clicking on a link sent by the networked coordinator 250.

In an alternate embodiment, the delivery agent 270 chat source is a chatterbot, talkbot, chatbot, bot, chatterbox, or other artificial conversational entity that conducts communication with the delivery recipient 220.

During the communications session, the delivery recipient 220 and the delivery agent 270 can discuss details associated with the delivery of a product, negotiate terms for the sale of a product, etc. The delivery agents 270-272 include manned and unmanned vehicles, which may be terrestrial-based such as cars, trucks, vans, buses, human-powered vehicles; aerial-based such as drones or unmanned aerial vehicles (UAVs), aircraft, and a space vehicles; and/or marine-based such as boats, ships, and watercraft.

In one embodiment, an electronic communication exchange is established or initiated by the networked coordinator 250. For example, the networked coordinator 250 or other entity may call or send an email, text message, video message, multimedia message, picture, social media message to the networked communications address of the delivery recipient. The electronic communication exchange may be established or initiated by a call center, an automated call system, an interactive voice response system (IVR), by computer or human action, by the supplier 230, by an electronic commerce company such as AMAZON.COM™, by one or more of the delivery agents 270-272, by a retailer or a wholesaler, or by any entity affiliated with any of the aforementioned entities. The electronic communication exchange may include information regarding the specific product, an offer for sale of the specific product, etc. The information and/or offer may include text, video, audio, or any combination thereof. The electronic exchange may be a one-way single communication or may be a bidirectional communication exchange or session. During the same, the parties may negotiate the terms of a sale of the specific product and/or arrange for payment thereof.

In one embodiment, after the electronic communication exchange and the delivery recipient 220 indicates a desire to purchase the product, the specific product which may have been previously pre-positioned with one or more delivery agents 270-272 is then assigned for delivery to the delivery recipient, at which time it could be addressed if desired to the delivery recipient 220. For example, the specific product can be packaged and/or addressed to the delivery recipient 220 as a result of the communication exchange, once it has been determined that the delivery recipient 220 will purchase the specific product. The electronic exchange may take place before or after one of the delivery agents 270-272, who will deliver the specific product, is identified by the networked coordinator 250. Thus, real-time or near real-time delivery of a specific product can be achieved.

As an example, the internet browsing habits of one or more potential delivery recipients may be identified. Based upon the identification of the browsing habits, a specific product of interest to one or more potential delivery recipients is determined. Thus, the electronic communication exchange may be made to each of the potential delivery recipients with the hopes of selling one or more of the specific products. For example, the web browsing histories of five persons is reviewing and a determination is made that each potential recipient is interested in a specific model of a notebook computer. Immediately or a short time after reviewing the web browsing histories and identifying an interest of those individuals in notebook computers (e.g., each potential recipient accessed a web page pertaining to the notebook computer), the pre-positioning of the specific notebook computers with delivery agents 270-272 can be done in real-time or near real-time. Before, during, or after this pre-positioning of the notebook computers with the delivery agents 270-272, the electronic communication exchange can be initiated with the networked communications address of the one or more potential delivery recipients 220 to make sales thereof to those potential delivery recipients 220 desiring to purchase the notebook computer.

As another example, before, during, or after a winter weather event, snow shovels, de-icers, and/or snow/ice melting products can be pre-positioned with delivery agents 270-272. Before, during, or after this pre-positioning of the snow shovels, de-icers, and/or snow/ice melting products with the delivery agents 270-272, the electronic communication exchange can be initiated with the networked communications address of the one or more potential delivery recipients 220 to make the sales thereof to those potential delivery recipients 220 desiring to purchase the respective products.

The identification of potential delivery recipients 220 in this regard can be made not only based on web browsing histories of the delivery recipients 220 and/or weather conditions as discussed above, but also based upon previous purchase patterns of the potential delivery recipients 220, seasonal trends, upcoming sporting events, conventions, etc. For example, an electronic communication exchange may be sent to potential delivery recipients 220 known to have purchased a ticket to a sporting event, with the intention of selling a pre-positioned product with a delivery agent 270 to one or more of the delivery recipients 220. In this regard, the networked coordinator 250 may receive notifications of purchases by individuals of products, and/or purchases of tickets to sporting events or other activities.

As another example, as the delivery agent 270 with a pre-positioned specific product approaches a certain delivery recipient 220, area, zip code, the networked coordinator 250 initiates the electronic communication exchange (e.g., text message, email, call) to potential delivery recipients 220, determined to be interested in the specific product, along a particular route with information indicating that a delivery with the specific product is on its way. If even one of the potential delivery recipients is interested in purchasing the product, the delivery agent 270 will make the delivery. As another example, potential delivery recipients 220 having an identified interest in a specific product within a particular zip code, block, parish, or area could receive the electronic communication exchange and could indicate in a reply where they would like to meet the delivery agent 270 for concluding the transaction.

The communications devices 273-275 of the delivery agents 270-272 are also configured to receive location information of the delivery recipient 220 and other coordination information from the networked coordinator 250 and/or the user device 210. Communications devices 273-275 of the delivery agents 270-272 may include a computer, a mobile computer, a PC, a laptop computer, a tablet computer, a wireless smart phone, a cell phone, a mobile phone, a tablet, an STB, a PDA, a GPS, a camera, a web appliance, smart glasses, etc. The communications devices 273-275 of the delivery agents 270-272 also include a client application that enables the transmission and reception of data from other communications devices on the network 290. Using the received location information of the delivery recipient 220, each of the delivery agents 270-272 are directed to the delivery recipient 220 or other designated location via information received from the communications devices 273-275.

In one embodiment, the location information of the user device 210 of the delivery recipient 220 is not static. That is, the delivery recipient 220 may be en route to, for example, a golf course, to work, to a ball game, etc., such that the delivery agent 270 would meet the delivery recipient 220 at a particular geographic location. For example, the networked coordinator 250 receives updated geographical location information from the user device 210 and transmits the dynamic geographical location information of the user device 210 of the delivery recipient 220 to the delivery agent 220 at predetermined intervals. In this fashion, the networked coordinator 250 will coordinate the delivery of the specific product based on two moving entities, e.g., the delivery recipient 220 and the delivery agent 270.

With the en route embodiment, during the chat session, a mutually convenient drop-off/pick-up location may be arranged. Advantageously, the delivery recipient 220 need not wait at a particular location to arrange for a delivery by the delivery agents 270-272.

In one embodiment, the delivery agents 270-272 are commercially operated. In another embodiment, the delivery agents 270-272 are individually owned by persons unaffiliated with the supplier 230, e.g., UBER™ drivers. For example, the delivery agents 270-272 may be a recreational UAV or personally owned vehicle. For delivery agents 270-272 that are unmanned vehicles, then spoken communication with the delivery recipient 220 may be with an operator or agent of the unmanned vehicles.

In another embodiment, the delivery agents 270-272 have a working relationship with one or more delivery companies such as FEDEX™, whereby the delivery agents 270-272 accept one or more packages and provide for delivery to the delivery recipient 220. The delivery agents 270-272 may be registered with the networked coordinator 250 and/or supplier 230.

In another embodiment, the delivery agents 270-272 can submit offers for a given delivery. For example, the networked coordinator 250 may transmit a message to a plurality of UBER™ delivery agents 270-272 indicating that a specific product must be delivered to a delivery recipient 220 at a particular geographical location. In response, the UBER™ delivery agents 270-272 would submit respective offers as to how much they would charge to pick-up the specific product and make the delivery. The networked coordinator 250 may decide to accept an offer of one UBER™ delivery agent over another based upon amount of the offers, location of the UBER™ delivery agents 270-272, timeliness to deliver the product based on existing traffic conditions, or other factors.

While the term product is used herein, it is understood that the product includes a service to be provided. In another embodiment, rather than a product being delivered to the delivery recipient, a package may be picked up one of the delivery agents 270-272 for shipping by the delivery recipient 220. For example, the delivery recipient 110 may wish to return a previously purchased product.

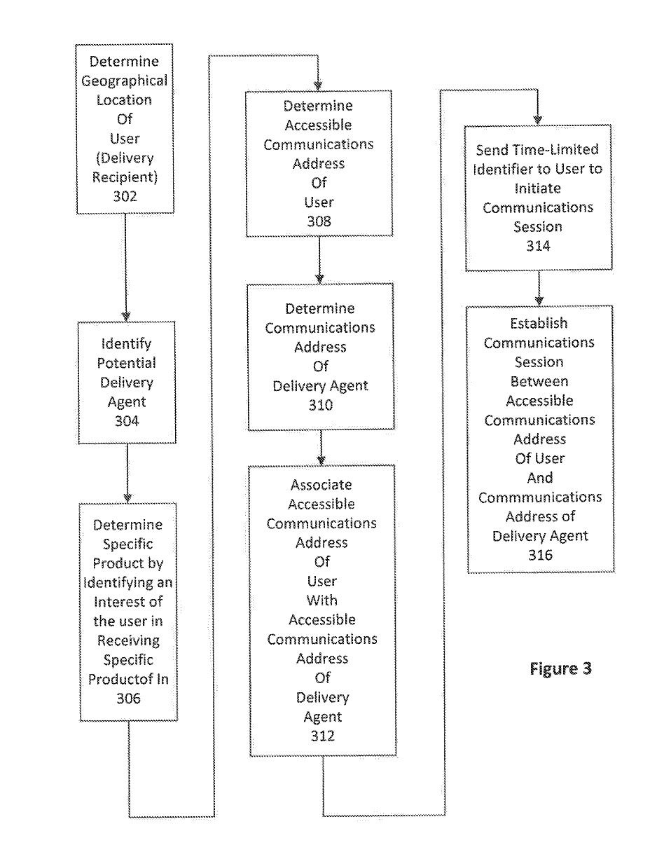

In FIG. 3, an exemplary flowchart for coordinating a delivery by a selected delivery agent to a delivery recipient is shown. At step 302, the networked coordinator 250 determines a geographical location of the delivery recipient 220 in a manner discussed. At step 304, the networked coordinator 250 identifies a potential delivery agent 270, of the one or more delivery agents 270-272, capable of delivery a specific product to the delivery recipient at the geographical location of the delivery recipient 220. In one embodiment, the networked coordinator 250 determines the location of the one or more delivery agents 270-272 via GPS coordinates of the delivery agent communications devices 273-275, along with the actual or planned route of the one or more delivery agents 270-272 and determines whether an overlap or near overlap exists between the one or more delivery agents 270-272 and the delivery recipient 220. For example, the networked coordinator 250 uses generated maps, as will be discussed later, to determine which of the one or more delivery agents 270-272 will be along a route near to the shipping destination of the delivery recipient 220.

At step 306, the supplier 230 determines the specific product by identifying an interest of the delivery recipient 220 in receiving the specific product. The identification of the specific product of interest may be determined in various manners. The identification of the specific product of interest may be identified as a result of content pushed and/or pulled from the delivery recipient 220 of the user device 210. In one embodiment, this may also include reviewing accessories or complementary products associated with a particular product.

In one embodiment, the specific product of interest may be determined from information provided by the delivery recipient 220 during the registration process in the opt-in embodiment. In another embodiment, the specific product of interest may be determined by reviewing the delivery recipient's web browsing habits, purchase history, and application usage, etc.

Determining the specific product of interest may include assessing an online purchase history of the delivery recipient and an online inquiry history of the delivery recipient 220 regarding the specific product. For example, if the delivery recipient 220 has purchased a particular product online or the delivery recipient 220 has made one or more online inquiries regarding a specific product determined by clicks on a web page or a product on a web page, then a determination may be made that the delivery recipient 220 has an interest in the specific product.

In one embodiment, information regarding the identified specific product of interest of the delivery recipient 220 may be pushed to the delivery recipient 220 at the user device 210. The pushed content may include information regarding the specific product and/or an offer to purchase the specific product. For example, the pushed content may be sent to the user device 210 via an email message, text message, automated phone call message.

The specific product of interest of the delivery recipient may be ascertained via web profiling or cookie profiling. That is, the supplier or other website may store cookies automatically by storing a text file containing encrypted data on the user device 210 or web browser when the delivery recipient accesses an online web page. The cookies are collected to identify certain information about the delivery recipient 220, in order that targeted content may be sent to the delivery recipient 220.

In one embodiment, the specific product may be offered to the delivery recipient 220 when the online purchase history of the delivery recipient indicates that the delivery recipient 220 has not purchased the specific product (e.g., from the supplier 230) in a given period of time (e.g., three months) and when the online inquiry history of the delivery recipient indicates that the delivery recipient 220 has accessed online information about the specific product on a plurality of different instances (e.g., three instances) within a single online session. Such multiple instances of accessing online information about a specific product during a single online session may be indicative of a user performing comparison shopping, which demonstrates a strong interest in purchasing the product.

At step 308, the networked coordinator 250 determines a communications address of the delivery recipient 220 by which the delivery recipient 220 may be accessed, for example, in manner discussed above. At step 310, the networked coordinator 250 determines a communications address of the potential delivery agent identified from the one or more delivery agents 270-272, for example, in a manner discussed above.

At step 312, the networked coordinator 250 associates the network communications address of the delivery recipient 220 with the communications address of the delivery agent 270. That is, the addresses are mapped, as discussed above, so that a communications session between the parties may be established. By having the networked coordinator 250 associate the network communications address of the delivery recipient 220 with the communications address of the delivery agent 270, the respective communications addresses of the delivery recipient 220 and delivery agent 270 are not shared with one another, thus protecting the privacy of the same.

At step 314, the networked coordinator 250 sends an identifier to the delivery recipient 220 and/or to the delivery agent 270, usable by the party or parties receiving the identifier to initiate the communications session between the delivery recipient 220 and the delivery agent 270. In one embodiment, the identifier is active only for a predetermined period of time (e.g., fifteen minutes). In another embodiment, the identifier is active only for a time corresponding to an estimated amount of time of when the potential delivery agent is within a predetermined radius of the geographical location of the delivery recipient 220.

For example, the identifier may include a URL such as a temporary short URL having an expiry time based on a calculated estimated time that it would take the potential delivery agent to travel five miles from the geographical location of the delivery recipient 220, for example, using a radius around point technique. The estimated time could also take into account current traffic conditions, in which case a mapping application with traffic capabilities such as GOOGLE™ Maps may be accessed by a traffic monitor 654 of the networked coordinator 250. Alternatively, the identifier may be sent to the delivery recipient 220 by the delivery agent 270.

At step 316, the networked coordinator 250 establishes a communications session between the network communications address of the delivery recipient 220 with the communications address of the potential delivery agent 270, in a manner discussed above.

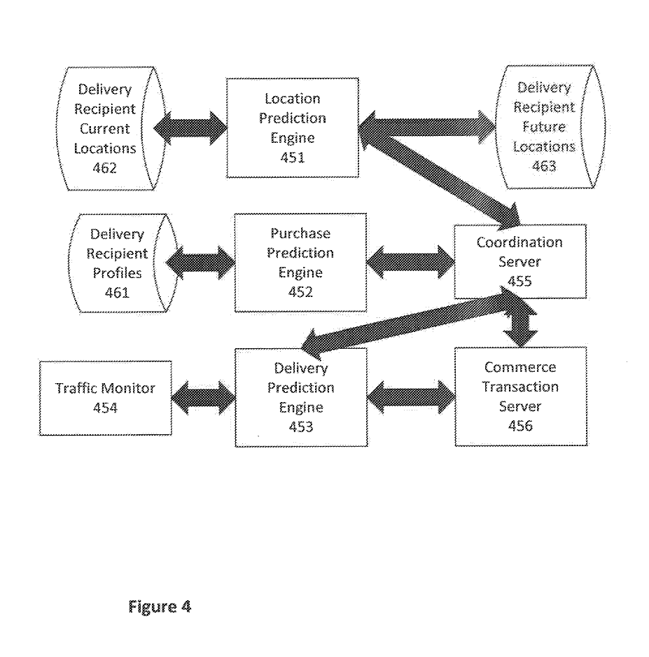

In FIG. 4, an exemplary component diagram of the networked coordinator is shown. The networked coordinator 250 includes a location prediction engine 451, a purchase prediction engine 452, a delivery prediction engine 453, a traffic monitor 454, a coordination server 455, and a commerce transaction server 456. The prediction engines employ any suitable predictive modelling techniques. In one embodiment, the aforementioned components of the networked coordinator 250 are separate processors, although, a single processor or any suitable combination of processors is contemplated.

The purchase prediction engine 452 identifies what products the delivery recipient 220 is likely to purchase. In this regard, the purchase prediction engine 452 analyzes the profile of the delivery recipient 220 to assess one or more of: the past purchases of the delivery recipient 220, the browsing history including what items the delivery recipient 220 viewed online, a wish list of items identified by the delivery recipient 220 in the opt-in user profile, items in an electronic shopping cart of the delivery recipient 220, and purchasing pattern data of other suppliers. These factors can be used to make a recommendation of a product to the delivery recipient by the supplier 230. The profiles of the delivery recipients 220 may be stored in a delivery recipient profile database 461 accessible by the purchase prediction engine 452.

In one embodiment, a product placed into an electronic shopping cart of a website of supplier 230, and then removed from the shopping cart, is quickly pre-positioned with a delivery agent 270. The delivery agent 270 is then directed by the networked coordinator 250 to an area near the location of the delivery recipient 220, and content regarding the product is pushed to the delivery recipient 220. In this fashion, the supplier 230 may assume that the delivery recipient 220 was on the verge of making a purchase with the supplier 230, but for some reason reconsidered. Thus, by pre-positioning the product near the delivery recipient 220 and pushing content to the user device 210, the supplier 230 may make the sale after all. The content may be pushed to the delivery recipient 220 based upon a distance from the delivery agent 270 to the delivery recipient 220, based upon a time estimate for the delivery agent 270 to travel to the delivery recipient 220 once the delivery agent is in the vicinity of the delivery recipient. The distance and or time estimate may be determined by the traffic monitor 454 and sent to the coordination server 455. The distance may be a predetermined distance, or may be based upon the type of vehicle or vehicle characteristic of the delivery agent 270. That is, it may be desired to have a smaller predetermined distance if the delivery agent 270 is a UAV.

The location prediction engine 451 identifies the current and/or predicted location of the delivery recipient 220 at a certain time, including when the delivery recipient 220 is en route by, for example, monitoring the receives GPS coordinates from the user device 210. In an alternative embodiment, the current and/or predicted location of a proxy for the delivery recipient 220 at a certain time may be identified. The current location of the delivery recipient 220 or proxy may be obtained by GPS coordinates, as discussed above. As another example, the predicted location of the delivery recipient 220 may be obtained by knowing the itinerary of the delivery recipient 220. As part of the opt-in arrangement, the delivery recipient 220 may provide certain information to the system that allows the system to know the intended schedule of the delivery recipient 220. Alternatively, the daily itinerary of the delivery recipient 220 may be learned over time by a machine learning process. That is, the system acquires the GPS coordinates of the delivery recipient's home and work addresses and the usual hours at each location from the user device 210. The location prediction engine 451 additionally creates aggregate map views based on where opt-in delivery recipients 220 are likely to be and at what times. The current and predicted future locations of the delivery recipients 220 may be stored in delivery recipient current and predicted future locations databases 462 and 463, respectively, accessible by the location prediction engine 451.

The purchase prediction engine 452 analyzes the GPS coordinates of opt-in delivery recipients 220 at times and days when the opt-in delivery recipients are predicted to be at locations associated with the GPS coordinates. Using this information, the purchase prediction engine 452 creates an aggregate map view based on where opt-in delivery recipients 220 who are likely to purchase an item are likely to be and at what time.

The delivery prediction engine 453 analyzes planned geographical route information for the one or more delivery agents 270-272, and combines predicted locations and times for delivery recipients 220 likely to purchase a specific product with planned vehicle routes to find geographic areas where there is an overlap between planned delivery agent routes and likely delivery recipient 220 locations of persons likely to purchase a product. Where an overlap exists, products can be pre-positioned with one or more delivery agents 270-272 who will be travelling in the areas where the likely delivery recipients are or will likely be in the future.

The traffic monitor 454 monitors current traffic conditions, for example, in the area of the delivery agent 270 and/or delivery recipient 220 using a mapping application having traffic information such as GOOGLE™ Maps. The traffic monitor 454 determines how long it would take a delivery agent 270 to traverse a particular route, for example, based upon distance and existing traffic conditions. Data from the traffic monitor 454 is shared with the delivery prediction engine 453. The networked coordinator 250, with the traffic monitor 454, may also monitor the distance between the delivery recipient 220 and the delivery agent 270 to know when to push content to the delivery recipient 220, e.g., when the two are within a predetermined distance and/or radius.

The coordination server 455 coordinates the flow of information between the location prediction engine 451, the purchase prediction engine 452, the delivery prediction engine 453, and the commerce transaction server 456. For example, the coordination server 455 may provide delivery recipient 220 location information and/or delivery agent 270 location information to the delivery prediction engine and/or the commerce transaction server 456. In an embodiment where the networked coordinator 250 coordinates the delivery of the specific product based on two moving entities (e.g., the delivery recipient 220 and the delivery agent 270), the coordination server 455 provides location of each entity to the delivery prediction engine 453 and the commerce transaction server 456.

The coordination server 455 may also send information to the delivery recipient 220 and/or delivery agents 270-272. Optionally, the coordination server 455 may also include a video receiver that receives video streams from an external source such as a delivery agent 270.

The commerce transaction server 456 monitors the location of the potential delivery agents 270-272 with pre-positioned products and the locations of delivery recipients 220 who have opted-in to location sharing, so that potential offers of products may be offered for purchase. The commerce transaction server 456 communicates with the delivery prediction engine 453 to coordinate the sending of content to the user device 210 and coordinate the purchase transaction, based upon the location of the delivery agent 270. When one of the potential delivery agents 270-272 is in the vicinity of a delivery recipient 220 an offer is pushed to the delivery recipient 220. If interested, the delivery recipient 220 can purchase the product identified in the pushed content via an electronic commerce exchange with the commerce transaction server 456. The commerce transaction server 456 notifies the identified delivery agent 270 of the transaction with the GPS-based delivery location of the user device 210. The delivery agent 270 can then proceed with a final delivery of the product. The delivery recipient 220 conducts the purchase transaction with the commerce transaction sever 456. In accordance with one embodiment, a future location of a delivery agent 270 may be matched with a delivery recipient 220 for the scheduling of a future taxi/Uber pickup.

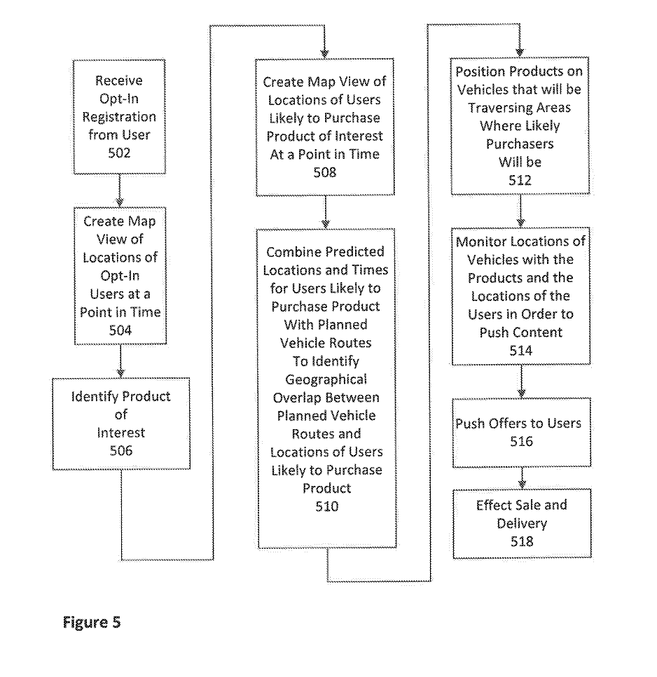

In FIG. 5, an exemplary flowchart for pre-positioning products based on predicted purchases and predicted geographic locations, according to an aspect of the present disclosure, is shown. At step 502, the networked coordinator 250 receives opt-in registration information from the user, for example, via an online form or other suitable manner as discussed above. At step 504, the location prediction engine 451 creates an aggregate map view based on where opt-in users are likely to be and at what time(s). At step 506, the purchase prediction engine 452 identifies likely purchasers of a specific product based on a delivery recipient's previous online activities (e.g., views of certain products), previous purchases, etc. At step 508, the purchase prediction engine 451 creates an aggregate map view based on where opt-in users who are likely to purchase the specific product are likely to be and when.

At step 510, the delivery prediction engine 453 combines predicted locations and times for delivery recipients 220 likely to purchase the specific product with planned vehicle routes to identify a geographical overlap between planned vehicle routes and locations of the users likely to purchase the specific product. At step 512, the networked coordinator 250 and/or supplier 230 transmits an instruction to one or more delivery agents 270-272 to pre-position products on vehicles that will be traversing areas where likely purchasers of the specific are determined to be based upon the overlap.

At step 514, the networked coordinator 250 monitors the locations of the delivery agents 270-272 with the products pre-positioned thereon and the locations of the opt-in users. When a particular delivery agent 270 is near to an opt-in user (e.g., delivery recipient 220) likely to be interested in a product carried by the particular delivery agent 270, then the networked coordinator 250 pushes content to the user device 210. The pushed content to the user device 210 may include an advertisement, announcement, coupon, or deal with respect to the product carried by the particular delivery agent 270. If the delivery recipient 220 is interested in the product associated with the pushed content, the delivery recipient 220 can contact respond to the pushed content or otherwise contact the delivery agent 270 to complete the sale and delivery process at step 518. As discussed above, in one embodiment, the networked coordinator 250 can send an identifier to the delivery recipient 220, which the delivery recipient 220 can access, for example, by clicking from the user device 210, which will initiate a communications chat session between the delivery recipient 220 and the potential delivery agent 270.

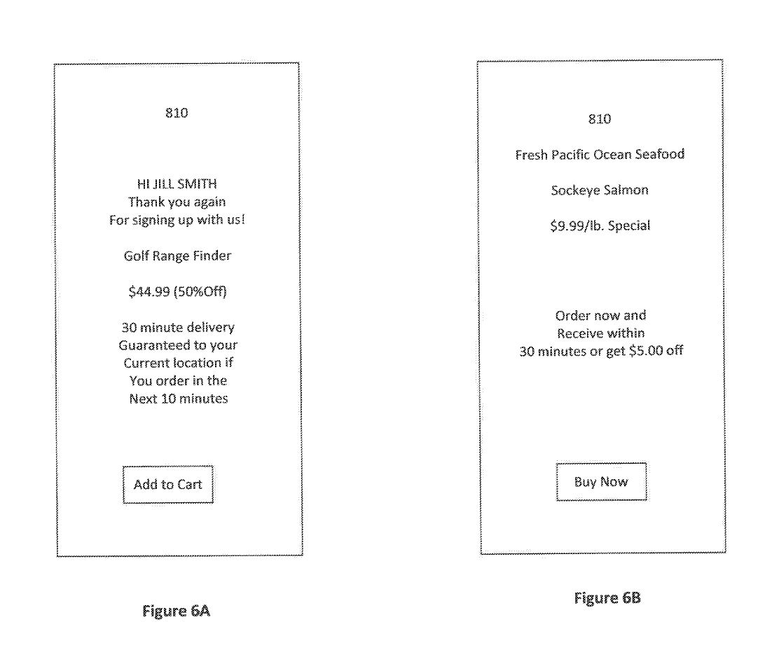

In FIGS. 6A and 6B, exemplary user interfaces are shown with pushed content from a supplier to a user device. In FIG. 6A, a special offer for a golf range finder is pushed to the user device 810, based on a determination that the user of the user device is likely to be interested in purchasing a golf range finder. For opt-in users, a personal greeting may be used, as shown in FIG. 6A. In FIG. 6B, a special offer for seafood is pushed to the user device 810, based on a determination the user of the user device is likely to be interested in purchasing fresh seafood.

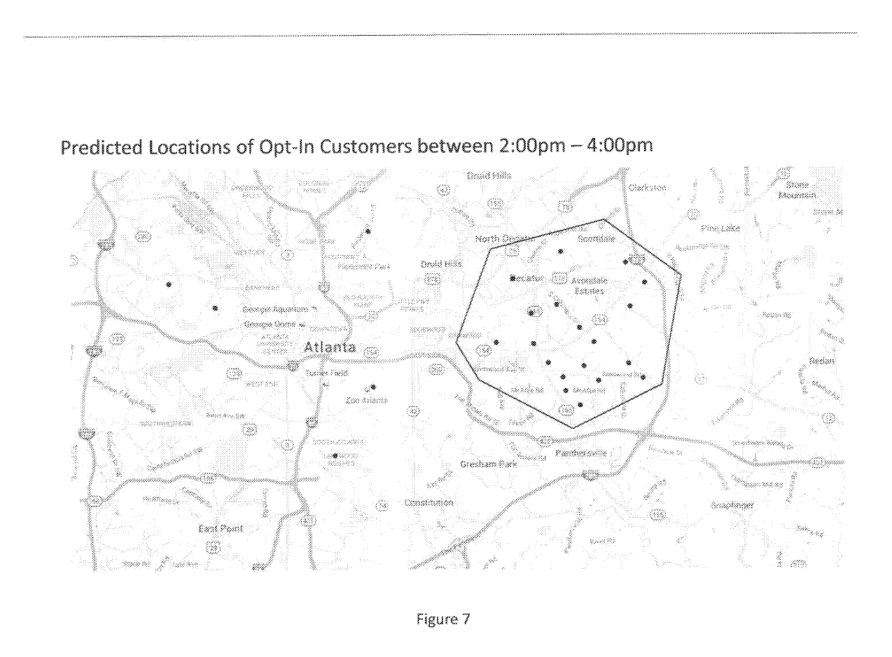

In FIG. 7, an exemplary map of predicted locations of opt-in users for a given time is shown. The location prediction engine 651 generates a map view, which may be displayed on a monitor, based on where opt-in delivery recipients 220 are likely to be and at what times. In this aggregated map view, the predicted locations of the opt-in delivery recipients 220 between 1400 hrs-1600 hrs are shown by the darkened dots. Additionally, the purchase prediction engine 652 generates a map view, which may also be displayed on a monitor, based on where opt-in users who are predicted to be likely to purchase an item are likely to be at what times. In one embodiment, the map view generated by the purchase prediction engine 652 is an overlay as shown by the polygon in FIG. 7.

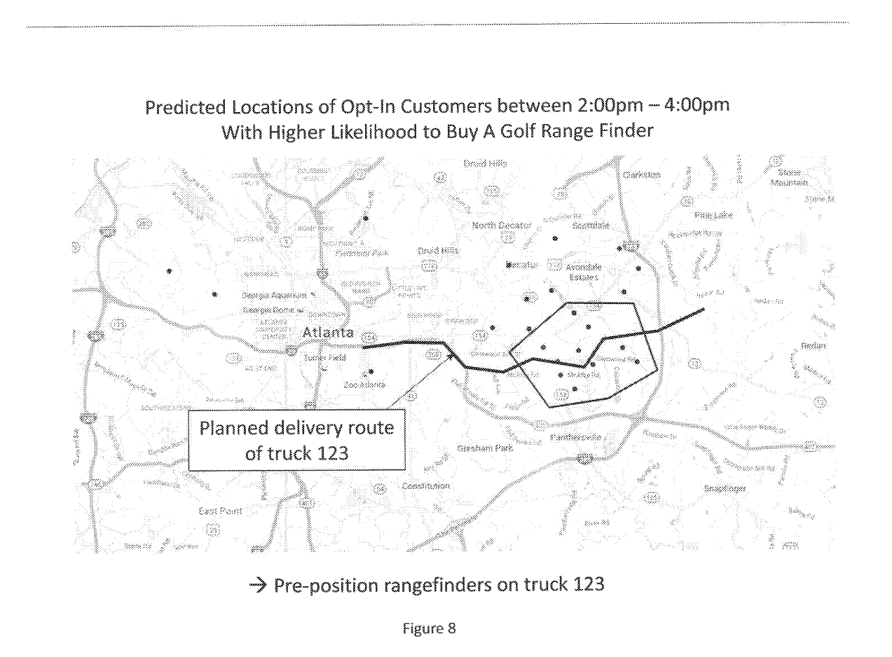

In FIG. 8, an exemplary map of predicted locations of opt-in users having a predicted likelihood of purchasing a particular product for a given time is shown. The delivery prediction engine 653 generates a map view which combines the predicted locations and times of opt-in user likely to purchase an item with planned vehicle routes to identify a corresponding overlap between the predicted locations of the potential purchasers at specific times who are likely to purchase the specific product (e.g., a golf range finder) and the planned geographical route information of the plurality of potential delivery agents. In the aggregated map view of FIG. 8, the predicted location opt-in delivery recipients between 1400 hrs-1600 hrs who are likely to purchase an item is combined with a planned delivery route, displayed for example by a polygon overlay, of a delivery agent through an identified region, i.e., truck 123 through the polygon overlay.

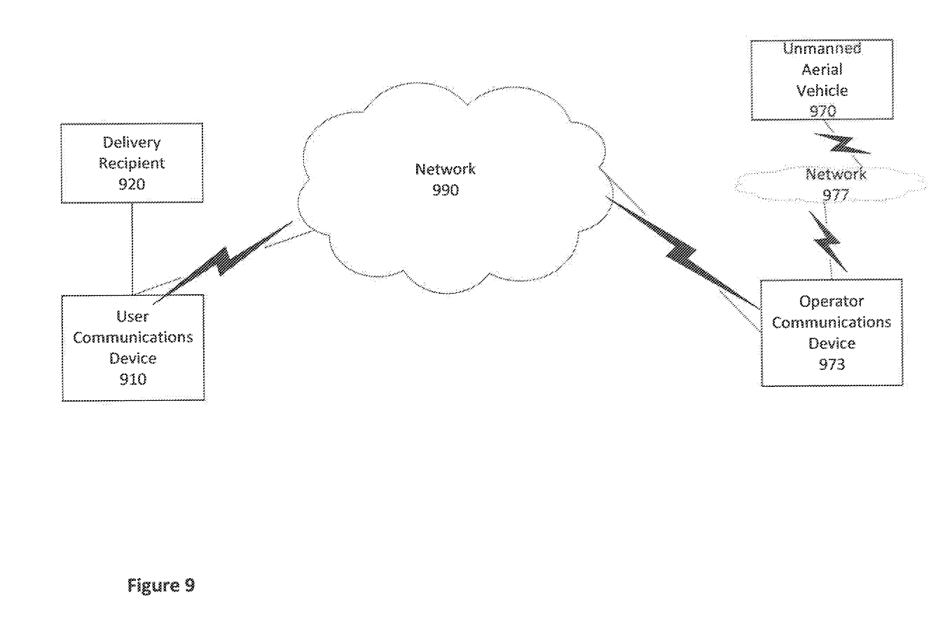

FIG. 9 shows an exemplary system for communications between a user communications device and an operator communications device, according to an aspect of the present disclosure. It is understood that any and all of the previously discussed features are also applicable to aspects disclosed in FIG. 9. The system of FIG. 9 includes a user communications device 910, a delivery recipient 920, a UAV 970, and operator communications device 973, a network 990, and a network 977. As previously discussed, the networked coordinator 250 is configured to send an identifier to the user communications device 210, 910 and delivery agent communications device 273, 973 to establish a communications session between the two. The delivery recipient 920 and UAV operator via the operator communications device 973 communicate via the network 990 to, for example, negotiate the purchase of the product being delivered by the UAV 970, or arrange for a drop off location of the product being delivered by the UAV 970. The UAV operator 973 communicates commands, GPS location information received from the networked coordinator 250 for example, and other signals to the UAV 970 via the network 977. The UAV 970 is configured to carry a product to a particular location, and after landing or descending to a suitable height, release the product. The network 977 may be a WiFi network or any other network suitable for the control of UAVs, including those on the 2.4 gigahertz spectrum. In the present example, communications between the delivery recipient 220 and an operator of a UAV is shown. It is understood that rather than a UAV 970, any other delivery agent such as those previously discussed are contemplated.

One scenario in this arrangement is to pre-position a product with an operator of the UAV 970, who may have the product loaded on the UAV 970, and flown near locations of delivery recipients 220 having a high likelihood of purchasing the product. Then, content may be pushed to the delivery recipient 220 as discussed above and delivery can be made to the delivery recipient 220. Advantageously, real-time or near real-time delivery is achieved.

In one embodiment, the UAV 970 is equipped with a camera having facial recognition software. The UAV 970, having a pre-positioned product thereon, can use the onboard facial recognition software to identify an opt-in delivery recipient 220. That is, the delivery recipient 220 previously uploaded a photo as part of the opt-in registration procedure. Once a positive identification of the delivery recipient 220 is made, the UAV 970 can transmit information to the networked coordinator 250, which may include the captured image of the delivery recipient 220 in a suitable database for matching. The networked coordinator 250 may also be equipped with facial recognition software to positively identify the delivery recipient as confirming the identification made by the UAV 970 software, or as a primary method of identification if the UAV 970 is not equipped with facial recognition software. Once positive identification has been established, and if necessary, confirmed, content regarding the pre-positioned product can be pushed to the delivery recipient 220, as discussed above. A positive facial recognition may be made in advance of establishing the electronic communication exchange.

In another embodiment, the networked coordinator 250 includes a display to view live video transmitted via a video camera on board the UAV 970. For example, the networked coordinator 250 can receive a video stream and determine on the fly, using facial recognition software, determine whether a person captured on video is the delivery recipient 220. The video stream may be compressed using a suitable video codec such as H.264 or VP8. The UAV 970 or a server communicating with the UAV 970 may communicate with the networked coordinator 250 using a suitable control protocol such as Microsoft™ Media Server (MMS) real time steaming protocol (RTSP). The networked coordinator 250 may include an audio-visual (AV) receiver, digital video recorder (DVR), or other receiver configured to receive and process video streams.

Instead of or in addition to facial recognition software, the UAV 970 may be equipped optical character recognition (OCR) software or license plate reader (LPR) technology to identify license plate information, or other alpha-numeric information, of delivery recipients 220. The UAV 970 can transmit information read by OCR or LPR to the networked coordinator 250, which can access an appropriate database to confirm the identity of the mobile delivery recipient 220. That is, the delivery recipient 220 may include license plate information as part of an opt-in registration process.

In one embodiment, using OCR or LPR, imaging technology on board the UAV 970 can scan license tag numbers, specialized license plates (e.g., a particular University), and/or bumper stickers to identify a delivery recipient 220.

As another example, an aggregated map views are created based on where opt-in delivery recipients are likely to be and when. For example, the aggregated map view includes at least one golf course in the Atlanta area on Saturday between 0800 hrs and 1400 hrs, known to be frequented by an opt-in delivery recipient 220 at that day and time. Another aggregated map view is created based on where delivery recipients likely to purchase a product will be and when. The supplier 230, with the aggregated map views, and knowing that the delivery recipient 220 has frequently made purchases of products or lessons designed to improve her golf game, can make a recommendation of a golf range finder to her. The supplier may pre-position a golf range finder with a delivery agent 270, 970 for potential sale to a delivery recipient 220 near a golf course, known to be frequented by the delivery recipient 220, on Saturday afternoon.

When the delivery agent 270 (or UAV 970) is near to the delivery recipient 220, content about the golf range finder can be pushed to the delivery recipient 220 with information about golf range finders, including an offer to purchase. If the delivery recipient 220 is interested, a communications session may be established between the delivery recipient 220 and the delivery agent 270 via an identifier may be sent by the networked coordinator. In another embodiment, no identifier is sent and no communications session is established, such that the delivery agent 270 or operator of the UAV 970 receives an indication from the delivery recipient 220, the supplier 230, and/or the networked coordinator 250 that the delivery recipient wishes to purchase the golf range finder.

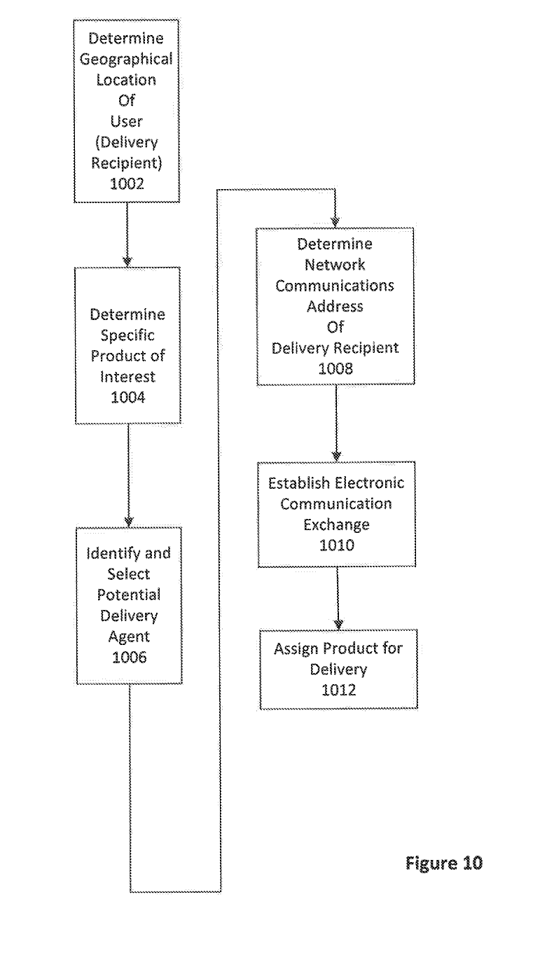

FIG. 10 shows an exemplary flowchart for coordinating a delivery by a selected delivery agent to a delivery recipient. At step 1002, a geographical location of at least one delivery recipient 220 is determined. At step 1004, an identification of a specific product of interest to the one or more delivery recipients 220 is made; although, the identification of the specific product may be made prior to the determination of the geographical location of the delivery recipient 220. At step 1006, an identification and selection of a delivery agent 270 is performed. At step 1008, a network communications address of the delivery recipient 220 is determined. The network communications address may be a phone number, an email address, and IP address, a SIP address, etc. At step 1010, an electronic communication exchange is established, for example, by the networked coordinator 250, so that the specific product may be assigned and/or addressed for delivery to the delivery recipient 220.

Accordingly, a method and system for coordinating a delivery by a selected delivery agent to a delivery recipient enables a robust solution for the delivery of products to consumers on a real-time of a near real-time basis, and the ability to pre-position shipments based on predicted purchases and predicted recipient locations.

Although a method and system for coordinating a delivery by a selected delivery agent to a delivery recipient has been described with reference to several exemplary embodiments, it is understood that the words that have been used are words of description and illustration, rather than words of limitation. Changes may be made within the purview of the appended claims, as presently stated and as amended, without departing from the scope and spirit of a method and system for coordinating a delivery by a selected delivery agent to a delivery recipient in its aspects. Although a method and system for coordinating a delivery by a selected delivery agent to a delivery recipient has been described with reference to particular means, materials and embodiments, a method and system for coordinating a delivery by a selected delivery agent to a delivery recipient is not intended to be limited to the particulars disclosed; rather a method and system for coordinating a delivery by a selected delivery agent to a delivery recipient extends to all functionally equivalent structures, methods, and uses such as are within the scope of the appended claims.

For example, rather than a delivery recipient 220, a match may be made with a predicted future location of a proxy for the delivery recipient 220. That is, the delivery recipient may, during the initial opt-in registration, include itinerary details (e.g., days and times at certain locations) about a proxy authorized to accept deliveries on behalf of the delivery recipient 220. In addition to itinerary details, other information about the proxy may be provided by the delivery recipient including communications address information.

As another example, a match may be made between a future location of one of the plurality of delivery agents 270-272 with a user, in which the one of the delivery agents can accept a package from the user to be delivered elsewhere. In this scenario, the identification of a location of the user (delivery recipient in the embodiments described above) and the identification of the delivery agent is achieved in the same manner as previously explained.

As another example, a match may be made between a future location of one or the plurality of delivery agents 270-272 with the future location of a person for scheduling a future taxi/UBER™ pickup. That is, instead of a product being provided to the delivery recipient 220, a transportation service is provided.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present specification describes components and functions that may be implemented in particular embodiments with reference to particular standards and protocols, the disclosure is not limited to such standards and protocols. For example, standards such as (TCP/IP, UDP, WiFi, RTP, SMS, SIP, CDMA, TDMA, GPS, GLONASS, GNSS, QZSS, BDS, IRNSS, WFPS, H.264, VP8, MMS, RTSP) represent examples of the state of the art. Such standards are periodically superseded by more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of the disclosure described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

According to one aspect of the present disclose a method of coordinating a delivery by a selected delivery agent to a delivery recipient is provided. The method includes determining a geographical receiving location for a delivery recipient, identifying and selecting, using a processor of a computer, a delivery agent, of a plurality of potential delivery agents, capable of delivering a specific product, determined to be of interest to the delivery recipient, at the geographical receiving location for the delivery recipient, the identifying including analyzing planned geographical routes for each of the plurality of potential delivery agents to determine the delivery agent. The method also includes determining a network communications address of the delivery recipient, and establishing, with a centralized networked node, an electronic communication exchange between an entity responsible for providing the specific product to the delivery recipient and the network communications address of the delivery recipient. The specific product is assigned for delivery to the delivery recipient based on the electronic communication exchange.

According to another aspect of the present disclosure, the method includes determining the specific product by identifying an interest of the delivery recipient in receiving the specific product, pushing content to a communications device of the delivery recipient regarding the specific product, and sending to the delivery recipient, an identifier, usable by the delivery recipient to initiate the electronic communication exchange with the delivery agent, the identifier being active only for a predetermined period of time corresponding to an estimated amount of time of when the delivery agent is within a predetermined radius of the geographical location of the delivery recipient.

According to yet another aspect of the present disclosure, determining the specific product includes assessing an online purchase history of the delivery recipient and an online inquiry history of the delivery recipient regarding the specific product, and offering the specific product to the delivery recipient when the online purchase history of the delivery recipient indicates that the delivery recipient has not purchased the specific product in a given period of time and when the online inquiry history of the delivery recipient indicates that the delivery recipient has accessed online information about the specific product on a plurality of different instances within a single online session.

According to still another aspect of the present disclosure, the estimated amount of time of when the delivery agent is within a predetermined radius of the geographical location of the delivery recipient is based upon an estimated amount of time for the delivery agent to traverse the predetermined radius according to existing traffic conditions.

According to another aspect of the present disclosure, the method includes determining the specific product by identifying an interest of the delivery recipient in receiving the specific product, the determining including reviewing an online user inquiry associated with the specific product, and sending an identifier to the delivery recipient usable by the delivery recipient to initiate the communication session with the delivery agent, the identifier being active only for a predetermined period of time corresponding to an estimated amount of time of when the delivery agent is within a predetermined radius of the geographical location of the delivery recipient.

According to yet another aspect of the present disclosure, the estimated amount of time of when the delivery agent is within a predetermined radius of the geographical location of the delivery recipient is based upon an estimated amount of time for the delivery agent to traverse the predetermined radius according to existing traffic conditions.

According to still another aspect of the present disclosure, determining a geographical receiving location of a delivery recipient includes predicting a future geographical location where the delivery recipient will be present.

According to another aspect of the present disclosure, the method includes generating a first map view display based on first predicted locations of potential delivery recipients at specific times, generating a second map view display based on second predicted locations of the potential delivery recipients who are likely to purchase the specific product, and combining the second map view with planned geographical route information of the plurality of potential delivery agents to identify and display a corresponding overlap between the second predicted locations of the potential delivery recipients who are likely to purchase the specific product and the planned geographical routes of the plurality of potential delivery agents, to position the specific product with the delivery agent. The position of the delivery agent is monitored as the delivery agent is en route to the geographical receiving location of the delivery recipient, to provide for the pushing of content associated with the specific product to the delivery recipient when the delivery agent is within a predetermined distance of the delivery recipient.

According to still another aspect of the present disclosure, determining a geographical receiving location of a delivery recipient includes predicting a future geographical location of the delivery recipient, based upon information provided by the delivery recipient during a registration procedure.

According to yet another aspect of the present disclosure, information provided by the delivery recipient during the registration procedure includes a daily itinerary of the delivery recipient.

According to another aspect of the present disclosure, the method includes sending to the delivery recipient, an identifier, usable by the delivery recipient to initiate the electronic communication exchange with the delivery agent, the identifier being active only for a predetermined period of time corresponding to an estimated amount of time of when the delivery agent is within a predetermined radius of the geographical location of the delivery recipient

According to yet another aspect of the present disclosure, the specific product includes a product determined to have been electronically placed into an electronic shopping cart and then removed from the shopping cart.

According to still another aspect of the present disclosure, the method includes monitoring a changing geographical location of the delivery recipient.

According to another aspect of the present disclosure, the method includes pushing content associated with the specific product to the delivery recipient when the delivery agent is within a predetermined distance of the delivery recipient. According to another aspect of the present disclosure, the predetermined distance is based on a vehicle characteristic of the delivery agent.

According to another aspect of the present disclosure, the method includes identifying a correspondence between predicted locations of potential delivery recipients determined to be likely to purchase the specific product and the planned geographical routes of the plurality of potential delivery agents.

According to yet another aspect of the present disclosure, the method includes receiving a video stream and analyzing the video stream to identify the delivery recipient in advance of establishing the electronic communication exchange. According to another aspect of the present disclosure, analyzing the video stream includes employing facial recognition technology.

According to another aspect of the present disclosure, a tangible non-transitory computer readable storage medium is provided that stores a computer program. The computer program, when executed by a processor, causes a computer apparatus to perform a process including determining a geographical receiving location for a delivery recipient, identifying and selecting, using a processor of a computer, a delivery agent, of a plurality of potential delivery agents, capable of delivering a specific product, determined to be of interest to the delivery recipient, at the geographical receiving location for the delivery recipient, the identifying including analyzing planned geographical routes for each of the plurality of potential delivery agents to determine the delivery agent. The process also includes determining a network communications address of the delivery recipient and establishing, with a centralized networked node, an electronic communication exchange between an entity responsible for providing the specific product to the delivery recipient and the network communications address of the delivery recipient. The specific product is assigned for delivery to the delivery recipient based on the electronic communication exchange.

According to another aspect of the present disclosure, a computer apparatus is providing including a memory that stores instructions, and a processor that executes the instructions. When executed by the processor, the instructions cause the processor to perform operations including determining a geographical receiving location for a delivery recipient, identifying and selecting, using a processor of a computer, a delivery agent, of a plurality of potential delivery agents, capable of delivering a specific product, determined to be of interest to the delivery recipient, at the geographical receiving location for the delivery recipient, the identifying including analyzing planned geographical routes for each of the plurality of potential delivery agents to determine the delivery agent. The process also includes determining a network communications address of the delivery recipient and establishing, with a centralized networked node, an electronic communication exchange between an entity responsible for providing the specific product to the delivery recipient and the network communications address of the delivery recipient. The specific product is assigned for delivery to the delivery recipient based on the electronic communication exchange.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The preceding description of the disclosed embodiments is provided to enable any person skilled in the art to make or use the present disclosure. As such, the above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1. A method of coordinating a delivery by a selected delivery agent to a delivery recipient, comprising:
determining a geographical receiving location for a delivery recipient;
identifying and selecting, using a processor of a computer, a delivery agent, of a plurality of potential delivery agents, capable of delivering a specific product, determined to be of interest to the delivery recipient, at the geographical receiving location for the delivery recipient, the identifying comprising analyzing planned geographical routes for each of the plurality of potential delivery agents to determine the delivery agent;
determining a network communications address of the delivery recipient; and
establishing, with a centralized networked node, an electronic communication exchange between an entity responsible for providing the specific product to the delivery recipient and the network communications address of the delivery recipient,
wherein the specific product is assigned for delivery to the delivery recipient based on the electronic communication exchange.

2. The method of claim 1, further comprising:
determining the specific product by identifying an interest of the delivery recipient in receiving the specific product;
pushing content to a communications device of the delivery recipient regarding the specific product; and
sending to the delivery recipient, an identifier, usable by the delivery recipient to initiate the electronic communication exchange with the delivery agent, the identifier being active only for a predetermined period of time corresponding to an estimated amount of time of when the delivery agent is within a predetermined radius of the geographical location of the delivery recipient.

3. The method of claim 2,
wherein the determining the specific product comprises assessing an online purchase history of the delivery recipient and an online inquiry history of the delivery recipient regarding the specific product, and
wherein the specific product is offered to the delivery recipient when the online purchase history of the delivery recipient indicates that the delivery recipient has not purchased the specific product in a given period of time and when the online inquiry history of the delivery recipient indicates that the delivery recipient has accessed online information about the specific product on a plurality of different instances within a single online session.

4. The method of claim 2, wherein the estimated amount of time of when the delivery agent is within a predetermined radius of the geographical location of the delivery recipient is based upon an estimated amount of time for the delivery agent to traverse the predetermined radius according to existing traffic conditions.

5. The method of claim 1, further comprising:
determining the specific product by identifying an interest of the delivery recipient in receiving the specific product, the determining comprising reviewing an online user inquiry associated with the specific product; and
sending an identifier to the delivery recipient usable by the delivery recipient to initiate the electronic communication exchange with the delivery agent, the identifier being active only for a predetermined period of time corresponding to an estimated amount of time of when the delivery agent is within a predetermined radius of the geographical location of the delivery recipient.

6. The method of claim 5,
wherein the estimated amount of time of when the delivery agent is within a predetermined radius of the geographical location of the delivery recipient is based upon an estimated amount of time for the delivery agent to traverse the predetermined radius according to existing traffic conditions.

7. The method of claim 1,
wherein determining a geographical receiving location of a delivery recipient comprises predicting a future geographical location where the delivery recipient will be present.

8. The method of claim 1, further comprising:
generating a first map view display based on first predicted locations of potential delivery recipients at specific times;
generating a second map view display based on second predicted locations of the potential delivery recipients who are likely to purchase the specific product;
combining the second map view with planned geographical route information of the plurality of potential delivery agents to identify and display a corresponding overlap between the second predicted locations of the potential delivery recipients who are likely to purchase the specific product and the planned geographical routes of the plurality of potential delivery agents, to position the specific product with the delivery agent;
monitoring the position of the delivery agent as the delivery agent is en route to the geographical receiving location of the delivery recipient; and
pushing content associated with the specific product to the delivery recipient when the delivery agent is within a predetermined distance of the delivery recipient.

9. The method of claim 1,
wherein determining a geographical receiving location of a delivery recipient comprises predicting a future geographical location of the delivery recipient, based upon information provided by the delivery recipient during a registration procedure.

10. The method of claim 9,
wherein the information provided by the delivery recipient during the registration procedure includes a daily itinerary of the delivery recipient.

11. The method of claim 1, further comprising sending to the delivery recipient, an identifier, usable by the delivery recipient to initiate the electronic communication exchange with the delivery agent, the identifier being active only for a predetermined period of time corresponding to an estimated amount of time of when the delivery agent is within a predetermined radius of the geographical location of the delivery recipient.

12. The method of claim 1, wherein the specific product comprises a product determined to have been electronically placed into an electronic shopping cart and then removed from the shopping cart.

13. The method of claim 1, further comprising monitoring a changing geographical location of the delivery recipient.

14. The method of claim 1, further comprising pushing content associated with the specific product to the delivery recipient when the delivery agent is within a predetermined distance of the delivery recipient.

15. The method of claim 1, wherein the predetermined distance is based on a vehicle characteristic of the delivery agent.

16. The method of claim 1, further comprising:
identifying a correspondence between predicted locations of potential delivery recipients determined to be likely to purchase the specific product and the planned geographical routes of the plurality of potential delivery agents.

17. The method of claim 1, further comprising receiving a video stream and analyzing the video stream to identify the delivery recipient in advance of establishing the electronic communication exchange.

18. The method claim 17, wherein analyzing the video stream includes employing facial recognition technology.

19. A tangible non-transitory computer readable storage medium that stores a computer program, the computer program, when executed by a processor, causing a computer apparatus to perform a process comprising:
determining a geographical receiving location for a delivery recipient;
identifying and selecting, using a processor of a computer, a delivery agent, of a plurality of potential delivery agents, capable of delivering a specific product, determined to be of interest to the delivery recipient, at the geographical receiving location for the delivery recipient, the identifying comprising analyzing planned geographical routes for each of the plurality of potential delivery agents to determine the delivery agent;
determining a network communications address of the delivery recipient; and
establishing, with a centralized networked node, an electronic communication exchange between an entity responsible for providing the specific product to the delivery recipient and the network communications address of the delivery recipient,
wherein the specific product is assigned for delivery to the delivery recipient based on the electronic communication exchange.

20. A computer apparatus, comprising:
a memory that stores instructions, and
a processor that executes the instructions,
wherein, when executed by the processor, the instructions cause the processor to perform operations comprising:
determining a geographical receiving location for a delivery recipient;
identifying and selecting, using a processor of a computer, a delivery agent, of a plurality of potential delivery agents, capable of delivering a specific product, determined to be of interest to the delivery recipient, at the geographical receiving location for the delivery recipient, the identifying comprising analyzing planned geographical routes for each of the plurality of potential delivery agents to determine the delivery agent;
determining a network communications address of the delivery recipient; and
establishing, with a centralized networked node, an electronic communication exchange between an entity responsible for providing the specific product to the delivery recipient and the network communications address of the delivery recipient,
wherein the specific product is assigned for delivery to the delivery recipient based on the electronic communication exchange.
